(19) United States
(12) Patent Application Publication
(10) Pub. No.: US 2010/0079261 A1
(43) Pub. Date: Apr. 1, 2010

(54) COMMUNICATION DEVICE, COMMUNICATION METHOD, COMPUTER PROGRAM AND COMPUTER SYSTEM

(75) Inventors: Tetsuro Goto, Kanagawa (JP); Shinichi Fukuda, Kanagawa (JP); Norihito Mihota, Saitama (JP); Masatoshi Ueno, Kanagawa (JP)

Correspondence Address: K&L Gates LLP, P. O. BOX 1135, CHICAGO, IL, 60690, US

(73) Assignee: SONY CORPORATION, Tokyo (JP)

(21) Appl. No.: 12/629,482

(22) Filed: Dec. 2, 2009

(30) Foreign Application Priority Data
Feb. 12, 2008 (JP) P2008-307931

(51) Int. Cl. H04Q 5/22

(52) U.S. Cl. 340/10.51

(57) ABSTRACT

A communication device includes: a first communication processing unit performing contactless communication operations in a first communication rate in which waveform distortion hardly become a problem; a second communication processing unit performing contactless communication operations in a second communication rate in which waveform shaping by adaptive equalization is necessary; and a control unit controlling communication processing by the first and second communication processing units, wherein the first communication processing unit stores the contents of a packet received in the first communication rate, and the second communication processing unit, when receiving the packet of the same contents in the second communication rate, performs adaptive equalization processing by using the stored contents of the packet.

### CROSS REFERENCES TO RELATED APPLICATIONS

The present application claims priority to Japanese Priority Patent Application JP 2008-307931 filed in the Japan Patent Office on Dec. 2, 2008, the entire contents of which is hereby incorporated by reference.

### BACKGROUND

The present application relates to a communication device, a communication method, a computer program and a communication system in which communication operation is performed as a reader/writer (initiator) transmitting a request command or a transponder (target) sending a response command with respect to the request command in contactless communication, and particularly relates to a communication device, a communication method, a computer program and a communication system performing contactless communication complying with a NFC (Near Field Communication) standard.

More particularly, the invention relates to a communication device, a communication method, a computer program and a communication system which solve disorder of a received waveform caused by speeding-up of a communication rate by adaptive equalization, and especially relates to a communication device, a communication method, a computer program and a communication system performing learning-type adaptive equalization while keeping compatibility of a packet format and a packet exchange procedure based on a given standard.

A contactless communication system called RFID (Radio Frequency Identification) is known as a communication system in which a communication terminal not having a generating source of radio waves for itself transmits data to a device to be the other party of communication by wireless. The RFID is also called as an ID system, a data carrier system and the like, however, the RFID system which is abbreviated as RFID is common worldwide. The RFID means an “identification system using a high frequency (radio wave)”.

The RFID system is applied to various contactless IC cards. An IC card system includes an IC (Integrated Circuit) card as a transponder and a device performing reading of information from the IC card or writing of information to the IC card (referred to as a “reader/writer” in the following description). Such IC card system is convenient because reading/writing of information is performed in a contactless manner between the IC card and the reader/writer. The reader/writer is a device which starts interactive communication by outputting an electromagnetic wave first (that is, the device which takes initiative of communication), which is also referred to as an “initiator”. The transponder such as the IC card is a “target” which sends a response (interactive communication start response) with respect to a command (interactive communication start request) from the initiator. In a passive mode, a carrier signal is constantly directed from the initiator to the target, whereas in the active mode, the carrier signal is switched alternately. In the following description, communication from the reader/writer to the transponder will be called a “down link” and communication from the transponder to the reader/writer is called “uplink”.

As contactless communication methods which can be applied to the RFID, an electrostatic method, an electromagnetic induction method, a radio wave communication method and the like can be cited. Among them, the electromagnetic induction method includes a primary coil on the reader/writer side and a secondary coil on the card (or the transponder) side, in which data communication is performed via the coils by magnetic coupling of these two coils. Specifically, the reader/writer transmits data by performing amplitude modulation on a magnetic field generated by the primary coil, and the transponder side detects the data. The transponder also performs modulation processing such as amplitude modulation by load switching (LS) of the secondary coil to thereby transmit data to the reader/writer. Each coil of the transponder and the reader/writer is operated as an LC resonant circuit, and the proper communication distance between the transponder and the reader/writer can be set by adjusting resonant frequencies of these coils to a carrier frequency used for communication to allow these coils to be resonant. In the following description, each coil of the transponder and the reader/writer is also referred to as an “antenna”.

The RFID system is classified into three types: a close coupled type (higher than 0 and lower than 2 mm), a proximity type (higher than 0 and lower than 10 cm) and a vicinity type (higher than 0 and lower than 70 cm) according to the transmission distance, which are prescribed by international standards such as ISO/IEC15693, ISO/IEC14443 and ISO/IEC15693, respectively. Among them, as contactless-proximity type IC card standards complying with ISO/IEC14443, Type A, Type B and Felica (trademark of Sony Corporation) can be cited. Type A corresponds to Mifare (trademark) of Royal Phillips Electronics. The card and the reader/writer as SmartCard are standardized as ISO7816.

Moreover, NFC (Near Field Communication) developed by Sony Corporation and Royal Phillips Electronics is an RFID standard prescribing specifications of an NFC communication device (reader/writer) which can communicate with respective IC cards of the above Type A, Type B and Felica mainly, which has become the international standard as ISO/IEC IS 18092 on December 2003. The NFC communication system takes over “Felica” of Sony Corporation and “Mifare” of Royal Phillips Electronics which have been widely used as a contactless IC card originally, which realizes the proximity-type contactless interactive communication of approximately 10 cm by using 13.56 MHz band in the electromagnetic induction method (NFC prescribes passive communication between the reader/writer and the reader/writer in addition to the communication between the card and the reader/writer).

Presently, NFC is extensively used for individual authentication, electronic money payment and the like. For example, an NFC communication device having an active mode in addition to the passive mode is proposed (for example, refer to JP-A-2005-168069 (Patent Document 1)).

A transfer direction, communication speed, a modulation method and an encoding method according to the communication mode in an NFC IP-1 (interface and Protocol-1) standard are shown in the following table 1.

TABLE 1

| transfer | communi- | A type | B type | Felica | |
|---|---|---|---|---|---|
| direction | cation speed | 106 kbps | 106 kbps | 212 kbps | 424 kbps |

| | | | | |
|---|---|---|---|---|
| reader/- | carrier frequency | 13.56 MHz | 13.56 MHz | 13.56 MHz |
| writer | modulation | 100% ASK | 10% ASK | 8-30% ASK |
| ↓ | method | | | |
| card | encoding method | deformed mirror | NRZ | Manchester |
| reader/- | sub-carrier | 13.56 MHz/-16 | 13.56 MHz/-16 | — |
| card | frequency | | | |
| ↓ | modulation | load | load | >12% ASK |
| writer | method | modulation | modulation | load |
| | | | | modulation |
| | encoding method | Manchester | BPSK-NRZ-L | Manchester |

In the electromagnetic-coupling type contactless communication specifications prescribed by ISO 18092, a Manchester code is used in Felica. In a Felica format, the same packet is used in downlink and uplink. In FIG. 11, a packet structure of the Felica format is shown. The shown packet includes three parts: “a preamble part (Preamble)”, “a sync part (SYNC)” and “a data part”. The preamble part has a “0” series of the 6-byte length, the sync part has a known series “0xB24D” of 2-byte. The data part has LEN of 1-byte indicating the packet length, a data body (payload) of (LEN-1) byte length and a CRC (Cyclic Redundancy Check) code of 2-byte. All these three parts are Manchester encoded.

In the Felica format, 424 kbps, 848 kbps, 1.7 Mbps, 3.4 Mbps and the like which are multiples of 212 kbps are prescribed as communication rates. As the communication rate is increased, the frequency band of a transmission signal is widened proportionally. As the frequency band of the signal is widened, effects of frequency characteristics in a channel, a transmission RF analog circuit and a reception RF analog circuit are increased. In the frequency characteristics, the attenuation is commonly increased as the frequency becomes higher. The disorder of phase characteristics is also increased as the frequency becomes higher. Accordingly, the higher the communication rate of the signal is, the more marked the disorder of the received waveform becomes. It is considered that effects of waveform distortion is more significant in the modulation of a transmission signal from the transponder side which uses load modulation than in the modulation of a transmission signal from the reader/writer side which uses amplitude (Amplitude Shift Keying: ASK) modulation.

As a method of compensating the disorder of a received signal in high-speed communication, adaptive equalization processing can be cited. For example, in a wireless communication system which transmits and receives information between a base station and a terminal station by a radio signal, a method of reducing distortion by shaping a waveform of a received signal using adaptive equalization processing is common for reducing communication errors due to the distortion of the received signal waveform caused by effects such as propagation delay due to multipath fading.

An adaptive equalization circuit includes a FIR (Finite Impulse Response) filter and a learning circuit as an example. A structure of the FIR filter is schematically shown in FIG. 12. The FIR filter includes a delay line in which plural delay elements are connected in series, which weights time-series input data for the numbers of arranged delay elements by tap coefficients in accordance with characteristics of the filter by multipliers respectively, then, accumulates and averages the data to obtain an equivalent signal. After that, the tap coefficients of the filter are determined so that the equivalent signal outputted from the FIR filter comes close to a desired signal by referring to a known training signal (for example, refer to JP-A-2004-64681 (Patent Document 2) and JP-A-2008-22422 (Patent Document 3)).

For example, an RFID system which reduces distortion in a radio-wave propagation path by applying an adaptive equalizer as well as reduces communication errors generated by the distortion is proposed (refer to JP-A-2008-27270 (Patent Document 4).

Here, as the adaptive equalization, it is possible to cite learning-type adaptive equalization determining a weight coefficient of a filter so that a filter output of itself comes close to a desired signal by referring to a known training signal and blind-type adaptive equalization determining a weight coefficient of the filter so as to suppress distortion in phase and amplitude by using autocorrelation of the received signal without using the training signal.

The blind-type adaptive equalization has advantages that the training signal is not necessary and it does not depend on transmission/modulation methods, however, there is a problem that the circuit scale and power consumption are increased because the calculation amount becomes enormous in the case that multipath waves having long delay time are assumed. When the adaptive equalization is applied to the contactless communication system such as Felica, the increase of the circuit scale and power consumption will be large obstacles particularly on the card side.

On the other hand, in the learning-type adaptive equalization, the training signal having the sufficient length is necessary. In the above Felica communication, as the communication rate becomes high from lower-speed 212 kbps or 424 kbps to 848 kbps, 1.7 Mbps and 3.4 Mbps, the distortion of the received waveform occurring on a channel is increased, as a result, a longer training signal will be necessary for the learning of the adaptive equalizer. In order to decode the data part in the packet from the head, it is necessary to complete the learning in a previous stage.

In the packet of the Felica format (refer to FIG. 11), a method of using the sync part of the two-byte length as it is as the training signal can be considered, however, the sync part is not sufficiently long and it can be assumed that a situation in which learning is not completed before the data part arrives. Even when the preamble part is used as the training signal, it is necessary to perform equalization processing at the beginning in 4 or 5-byte at the maximum length. In the communication system at high communication speed in which larger waveform distortion occurs in the received signal or using the encoding method having low noise resistance (for example, NRZ (Non Return to Zero) and the like), the data part of the packet arrives before weight coefficients of an equalization filter (equalizer) sufficiently converge, accordingly, communication errors occur.

Moreover, a method of inserting a random pattern which is sufficiently long for learning between the sync part and the data part, a method of transmitting a dedicated packet for learning before a normal packet and the like can be considered. However, in order to realize these methods, a packet format which is different from the Felica format is used, therefore, a problem concerning compatibility may occur.

In short, in order to improve the communication rate in the contactless communication system such as the Felica communication, it is necessary to perform learning-type adaptive equalization by using the training signal having the sufficient length, however, it conflicts with compatibility maintenance with respect to the packet format in an upper protocol.

### SUMMARY

It is desirable to provide an excellent communication device, a communication method, a computer program and a communication system suitably capable of solving disorder of a received waveform caused by speeding-up of a communication rate by adaptive equalization.

It is also desirable to provide an excellent communication device, a communication method, a computer program and a communication system capable of performing equalization processing of a received signal efficiently while maintaining compatibility without affecting a packet format in an upper protocol as well as without reducing a communication rate.

It is further desirable to provide an excellent communication device, a communication method, a computer program and a communication system capable of performing learning-type equalization processing by using a training signal having the sufficient length while maintaining compatibility without affecting the packet format in the upper protocol.

According to an embodiment, there is provided a communication device including a first communication processing unit performing contactless communication operations in a first communication rate in which waveform distortion hardly become a problem, a second communication processing unit performing contactless communication operations in a second communication rate in which waveform shaping by adaptive equalization is necessary and a control unit controlling communication processing by the first and second communication processing units, in which the first communication processing unit stores the contents of a packet received in the first communication rate, and the second communication processing unit, when receiving the packet of the same contents in the second communication rate, performs adaptive equalization processing by using the stored contents of the packet.

Also according to an embodiment, the second communication processing unit is configured to notify an equalization state of the adaptive equalization processing to the control unit. The control unit performs the adaptive equalization processing using the stored contents of the packet continuously until the equalization state is determined to be sufficient.

Also according to another embodiment, the communication device is applied to a contactless communication system including a reader/writer and a transponder, in which a polling command is transmitted from the reader/writer and a polling response is sent back from the transponder, the polling command is permitted to be continuously transmitted plural times from the reader/writer as well as the transponder sends back the polling response having the same contents with respect to the polling command having the same contents.

Also according to still another embodiment, the communication device according to an embodiment is operated as the reader/writer. The reader/writer transmits the polling command using the first communication processing unit and receives the polling response sent back from the transponder as well as stores the contents thereof, then, the reader/writer transmits the same polling command by using the second communication processing unit and performs adaptive equalization processing by using the stored contents of the packet when receiving the polling response sent back from the transponder.

Also according to yet another embodiment, the second communication processing unit in the communication device according to an embodiment of the invention notifies an equalization state of the adaptive equalization processing to the control unit, and the control unit transmits the same polling command again by using the second communication processing unit until the equalization state is determined to be sufficient, and performs adaptive equalization processing using the stored contents of the packet continuously when receiving the polling response sent back from the transponder.

Also according to still yet another embodiment, the communication device according to the embodiment of the invention is operated as the transponder. The transponder stores the contents of the polling command in response to normal reception of the command by the first communication processing unit as well as sends back the polling response, and the transponder receives the same polling command by the second communication processing unit and performs adaptive equalization processing by using the stored contents of the packet.

Also according to further embodiment, the second communication processing unit in the communication device according to the embodiment of the invention notifies an equalization state of the adaptive equalization processing to the control unit, and the control unit does not send back the polling response from the second communication processing unit until the equalization state is determined to be sufficient, receives the same polling command transmitted from the reader/writer again by the second communication processing unit and performs adaptive equalization processing continuously by using the stored contents of the packet.

According to still further embodiment, there is provided a communication method as a reader/writer in a contactless communication system including the reader/writer and a transponder, in which a polling command is transmitted from the reader/writer and a polling response is sent back from the transponder, the polling command is permitted to be continuously transmitted plural times from the reader/writer as well as the transponder sends back the polling response having the same contents with respect to the polling command having the same contents, which includes the steps of transmitting the polling command by performing a contactless communication operation in a first communication rate in which waveform distortion hardly become a problem, receiving the polling response sent back from the transponder and storing the contents thereof and transmitting the same polling command again by performing a contactless communication operation in a second communication rate in which waveform shaping by adaptive equalization is necessary until an equalization state is determined to be sufficient, and performing the adaptive equalization processing continuously by using the stored contents of the packet when receiving the polling response sent back from the transponder.

Also according to yet further embodiment, there is provided a communication method as a transponder in a contactless communication system including a reader/writer and the transponder, in which a polling command is transmitted from the reader/writer and a polling response is sent back from the transponder, the polling command is permitted to be continuously transmitted plural times from the reader/writer as well as the transponder sends back the polling response having the same contents with respect to the polling command having the same contents, which includes the steps of storing the contents of the polling command in response to normal reception of the command by performing a contactless communication operation in a first communication rate in which waveform distortion hardly become a problem as well as sending back the polling response and performing a contactless communication operation in a second communication rate in which waveform shaping by adaptive equalization is necessary without sending back the polling response until an equalization state is determined to be sufficient, and performing adaptive equalization processing continuously by using the stored contents of the packet when receiving the same polling command transmitted from the reader/writer again.

Also according to still yet further embodiment, there is provided a computer program written in a computer readable format so as to execute processing as a reader/writer on the computer in a contactless communication system including a reader/writer and a transponder, in which a polling command is transmitted from the reader/writer and a polling response is sent back from the transponder, the polling command is permitted to be continuously transmitted plural times from the reader/writer as well as the transponder sends back the polling response having the same contents with respect to the polling command having the same contents, allowing a computer to execute the steps of transmitting the polling command by performing a contactless communication operation in a first communication rate in which waveform distortion hardly become a problem, receiving the polling response sent back from the transponder and storing the contents thereof and transmitting the same polling command again by performing a contactless communication operation in a second communication rate in which waveform shaping by adaptive equalization is necessary until an equalization state is determined to be sufficient, and performing the adaptive equalization processing continuously by using the stored contents of the packet when receiving the polling response sent back from the transponder.

Also according to further embodiment, there is provided a computer program written in a computer readable format so as to execute processing as a transponder on the computer in a contactless communication system including a reader/writer and a transponder, in which a polling command is transmitted from the reader/writer and a polling response is sent back from the transponder, the polling command is permitted to be continuously transmitted plural times from the reader/writer as well as the transponder sends back the polling response having the same contents with respect to the polling command having the same contents, allowing a computer to execute the steps of storing the contents of the polling command in response to normal reception of the command by performing a contactless communication operation in a first communication rate in which waveform distortion hardly become a problem as well as sending back the polling response and performing a contactless communication operation in a second communication rate in which waveform shaping by adaptive equalization is necessary without sending back the polling response until an equalization state is determined to be sufficient, and performing adaptive equalization processing continuously by using the stored contents of the packet when receiving the same polling command transmitted from the reader/writer again.

The computer program according to an embodiment defines a computer program written in the computer readable format so as to execute given processing on the computer. In other words, the computer program according to the embodiment is installed in the computer, thereby realizing cooperative operation on the computer, as a result, the same effects as the communication device according to an embodiment can be obtained.

Also according to a still further embodiment, there is provided a contactless communication system including a reader/writer and a transponder, in which a polling command is transmitted from the reader/writer and a polling response is sent back from the transponder, the polling command is permitted to be continuously transmitted plural times from the reader/writer as well as the transponder sends back the polling response having the same contents with respect to the polling command having the same contents, in which the reader/writer transmits the polling command by performing a contactless communication operation in a first communication rate in which waveform distortion hardly become a problem, receives the polling response sent back from the transponder and storing the contents thereof, then, transmits the same polling command again by performing a contactless communication operation in a second communication rate in which waveform shaping by adaptive equalization is necessary until an equalization state is determined to be sufficient, and performs the adaptive equalization processing continuously by using the stored contents of the packet when receiving the polling response sent back from the transponder, and the transponder stores the contents of the polling command in response to normal reception of the command by performing a contactless communication operation in the first communication rate in which waveform distortion hardly become a problem as well as sends back the polling response, then, performs a contactless communication operation in a second communication rate in which waveform shaping by adaptive equalization is necessary without sending back the polling response until an equalization state is determined to be sufficient, further, performs adaptive equalization processing continuously by using the stored contents of the packet when receiving the same polling command transmitted from the reader/writer again.

According to yet a further embodiment, there is provided a communication system including a reader/writer and a transponder, in which a polling command is transmitted from the reader/writer and a polling response is sent back from the transponder, the polling command is permitted to be continuously transmitted plural times from the reader/writer as well as the transponder sends back the polling response having the same contents with respect to the polling command having the same contents, in which, after the reader/writer and the transponder exchange the polling command and the polling response by performing contactless communication operation in a first communication rate, the reader/writer and the transponder further exchange the polling command and the polling response by performing contactless communication operation in a second communication rate to perform subsequent protocol processing in the second communication rate.

The “system” indicates a logical aggregation of plural apparatuses (or function modules realizing specific functions), and whether respective apparatuses or function modules are in a single casing or not is no object.

According to an embodiment, it is possible to provide an excellent device, a communication method, a computer program and a communication system suitably capable of solving the disorder of a received waveform due to speeding-up of a communication rate by adaptive equalization.

Also according to embodiment, it is possible to provide an excellent device, a communication method, a computer program and a communication system capable of performing equalization processing of a received signal efficiently while maintaining compatibility without affecting a packet format in an upper protocol as well as without reducing a communication rate.

Also according to an embodiment, it is possible to provide an excellent device, a communication method, a computer program and a communication system capable of performing learning-type equalization processing by using a training signal having the sufficient length while maintaining compatibility without affecting the packet format in the upper protocol.

According to an embodiment, it is possible to exchange a training signal for learning of adaptive equalization with respect to the other party of communication by using a first communication rate in which waveform distortion does not become a problem before starting contactless communication in a second communication rate in which adaptive equalization processing is absolutely necessary. According to an embodiment, it is possible to perform adaptive equalization processing using the stored contents of the packet continuously until an equalization state is determined to be sufficient.

According to an embodiment, it is possible to perform equalization processing at the time of high-speed communication in the contactless communication system of, for example, a Felica standard while maintaining compatibility without affecting an upper protocol format at all as well as almost without changing an upper control program.

Further another characteristics and advantages of the invention will be clarified by detailed description based on later-described embodiments and attached drawings.

Additional features and advantages are described herein, and will be apparent from the following Detailed Description and the figures.

### BRIEF DESCRIPTION OF THE FIGURES

FIG. 1 is a diagram mainly showing a configuration example of an inductive coupling part of an electromagnetic-induction type contactless communication system having a transponder and a reader/writer;

FIG. 2 is a diagram schematically showing a configuration of a contactless communication system according to an embodiment;

FIG. 3 is a diagram showing an internal configuration example of an adaptive equalization unit which can be applied to a high-speed communication/adaptive equalization processing unit 15 on a reader/writer 10 side as well as a high-speed communication/adaptive equalization processing unit 36 on the transponder 30 side;

FIG. 4 is a table showing a format of a polling command POL transmitted from the reader/writer 10;

FIG. 5 is a table showing a format of a polling response POLRES transmitted from the transponder 30;

FIG. 6 is a view showing a processing sequence of a polling command by known communication in a Felica communication system shown in FIG. 2;

FIG. 7 is a diagram showing a time-slot control of the polling response packet POLRES;

FIG. 8 is a view showing a state in which the reader/writer 10 performs polling processing by the operation of the transponder 30 by a user in the common Felica communication system;

FIG. 9 is a view showing mode transition of the transponder 30;

FIG. 10A is a diagram showing an equalization processing sequence (pre-polling) in the high-speed communication using the polling command POL and the polling response POLRES;

FIG. 10B is a diagram showing an equalization processing sequence (main-polling) in the high-speed communication using the polling command POL and the polling response POLRES;

FIG. 10C is a diagram showing an equalization processing sequence (protocol processing in the subsequent stage) using the polling command POL and the polling response POLRES;

FIG. 11 is a table showing a packet structure of the Felica format; and

FIG. 12 is a diagram schematically showing a configuration of a FIR filter.

### DETAILED DESCRIPTION

The present application will be explained in detail with reference to the drawings according to an embodiment.

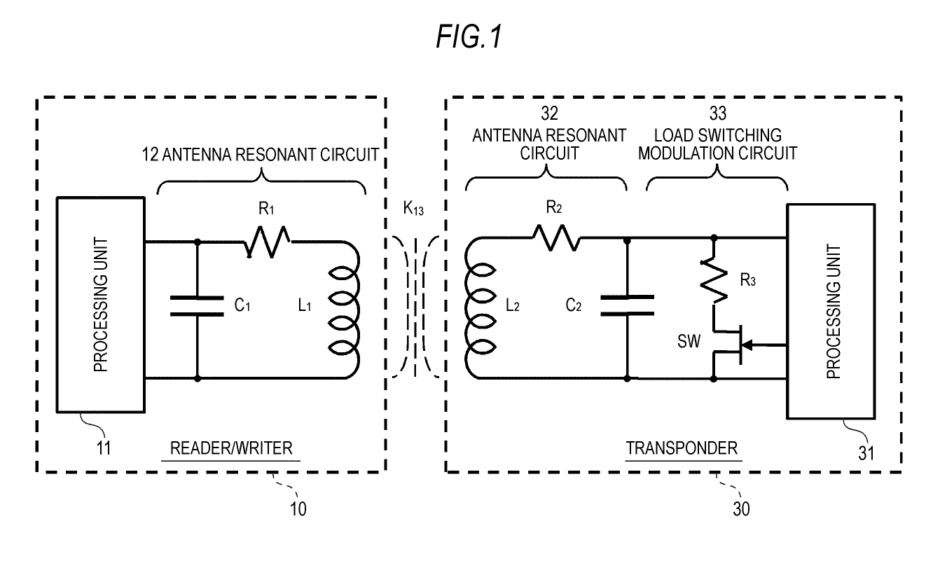

FIG. 1 mainly shows a configuration example of an inductive coupling part of an electromagnetic-induction type contactless communication system having a transponder and a reader/writer. Antenna resonant circuits 12, 32 respectively included in a reader/writer 10 and a transponder 30 are electromagnetically coupled to perform exchange of an information signal.

The antenna resonant circuit 12 of the reader/writer 10 includes a resistance R1, a capacitor C1 and a coil L1, transmitting an information signal generated by a processing unit 11 to the transponder 30 side. The antenna resonant circuit 12 receives the information signal from the transponder 30, supplying the signal to the processing unit 11. A natural resonant frequency of the antenna resonant circuit 12 is previously set to a given value by capacitance of the capacitor C1 and inductance of the coil L1.

On the other hand, the antenna resonant circuit 32 of the transponder 30 includes a resistance R2, a capacitor C2 and a coil L2, transmitting the information signal generated by the processing unit 31 and modulated by a load switching modulation circuit 33 to an antenna (coil L2) on the reader/writer 10. The antenna resonant circuit 32 also receives the information signal from the reader/writer side and supplies the signal to the processing unit. A resonant frequency of the antenna resonant circuit 32 is previously set to a given value by capacitance of the capacitor C2 and inductance of the coil L2.

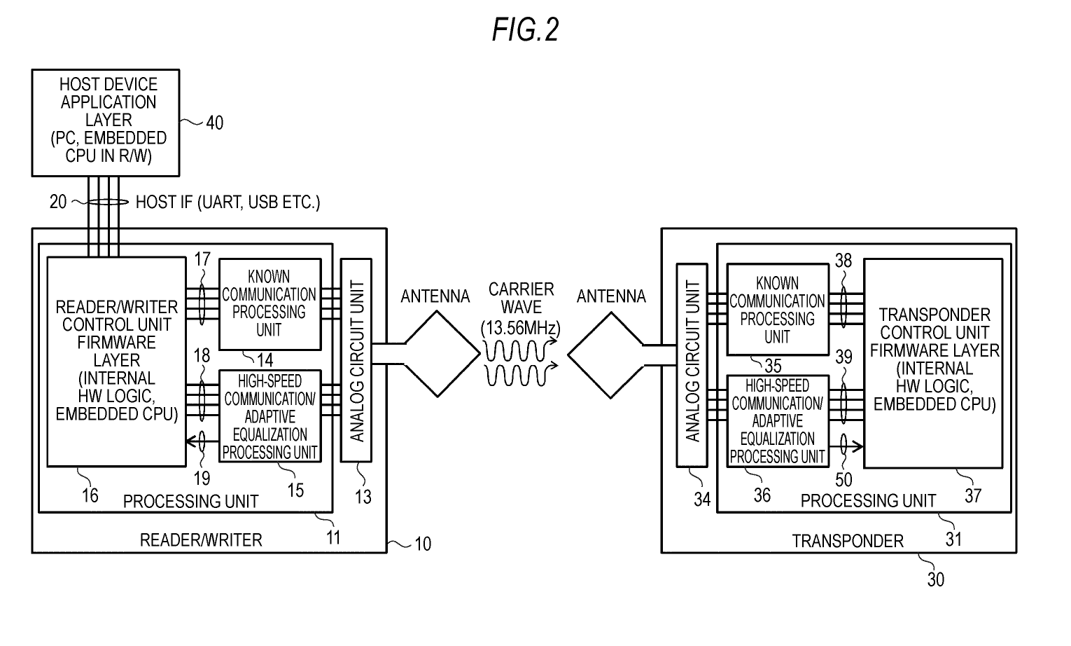

FIG. 2 schematically shows a configuration of the contactless communication system according to an embodiment. The shown communication system includes the reader/writer 10 complying with an NFC IP-1 standard and a transponder 30 including a Felica standard card, performing passive interactive communication in a Felica communication system by using the above electromagnetic induction principle.

The reader/writer 10 includes the processing unit 11 and an analog circuit unit 13 (having the analog resonant circuit 12 and the like) to which an antenna (corresponding to the coil L1) is connected. The processing unit 11 includes a known communication processing unit 14 performing known communication which is relatively low in speed such as 212 kbps and 414 kbps, a high-speed communication/adaptive equalization processing unit 15 performing high-speed communication such as 848 kbps, 1.7 Mbps and 3.4 Mbps as well as adaptive equalization processing of a received signal and a reader/writer control unit 16.

The known communication processing unit 14 performs processing of a physical layer and a data link layer when performing known communication in the communication system shown in FIG. 2. The known communication processing unit 14 is connected to the reader/writer control unit 16 through a known communication control line 17 as well as connected to the antenna through the analog circuit unit 13.

The high-speed communication/adaptive equalization processing unit 15 performs processing of the physical layer and the data link layer when performing high-speed communication in the communication system shown in FIG. 2 as well as performs learning-type adaptive equalization processing to the received signal. The details of the adaptive equalization processing will be described later. The high-speed communication/adaptive equalization processing unit 15 is connected to the reader/writer control unit 16 through a high-speed communication control line 18 as well as connected to the antenna through the analog circuit unit 13. The high-speed communication/adaptive equalization processing unit 15 transmits a progress state of equalization processing at the high-speed communication to the reader/writer control unit 16 through an equalization state transmitting signal 19.

The reader/writer control unit 16 is connected to a host device 40 through a host interface 20, taking charge of processing of upper layers from a network layer to a presentation layer in the communication system. The reader/writer control unit 16 is mounted in a form of, for example, a micro-program of hardware logic or a ROM (Read Only Memory) program of an embedded CPU (Central Processing Unit). In the present embodiment, the reader/writer control unit 16 controls a polling processing procedure at the high-speed communication according to the progress state of equalization processing transmitted through equalization state transmitting signal 19, and the details will be described later.

The host device 40 includes a PC (Personal Computer) and an integrated CPU, taking charge of an application layer in the communication system shown in FIG. 2. When the host device 40 is the PC, a USB (Universal Serial Bus), a UART (Universal Asynchronous Receiver-Transmitter) and the like are used as a host interface 20. When the host device is the embedded CPU, an AMBA, an AHB bus, I2C serial interface and the like are used as the host interface 20.

The transponder 30 includes the processing unit 31 and an analog circuit unit 34 (having the analog resonant circuit 32, the load switching modulation circuit 33 and the like) to which the antenna (corresponding to L2) is connected. The processing unit 31 includes a known communication processing unit 35 performing known communication which is relatively low in speed such as 212 kbps, 424 kbps, a high-speed communication/adaptive equalization processing unit 36 performing high-speed communication such as 848 kbps, 1.7 Mbps and 3.4 Mbps as well as adaptive equalization processing of the received signal and a transponder control unit 37.

The known communication processing unit 35 performs processing of the physical layer and the data link layer when performing known communication in the communication system shown in FIG. 2. The known communication processing unit 35 is connected to the transponder control unit 37 through a known communication control line 38 as well as connected to the antenna through the analog circuit unit 34.

The high-speed communication/adaptive equalization processing unit 36 performs processing of the physical layer and the data link layer when performing high-speed communication in the communication system shown in FIG. 2 as well as performs learning-type adaptive equalization processing to the received signal. The details of the adaptive equalization processing will be described later. The high-speed communication/adaptive equalization processing unit 36 is connected to the transponder control unit 37 through a high-speed communication control line 39 as well as connected to the antenna through the analog circuit unit 34. The high-speed communication/adaptive equalization processing unit 36 transmits the progress state of equalization processing at the high-speed communication to the transponder control unit 37 through an equalization state transmitting signal 50.

The transponder control unit 37 takes charge of processing of upper layers from a network layer to a presentation layer in the communication system. In the transponder control unit 37, a storage memory 37A including an EEPROM (Electrically Erasable and Programmable ROM) and the like is arranged, which is used for storing various data such as value information. However, an operation method itself of value information is not relevant to the gist of the invention, therefore, the detailed description concerning this point is omitted in the specification. Also in the transponder control unit 37, unique parameters IDm and PMm (described later) of 16-byte in a not-shown ROM area are stored. It is difficult that the user change IDm and PMm. The transponder control unit 37 is mounted in a form of, for example, a micro-program of hardware logic or a ROM program of an embedded CPU. In the present embodiment, the transponder control unit 37 controls a polling processing procedure at the high-speed communication according to the progress state of equalization processing transmitted through the equalization state transmitting signal 50, and the details thereof will be described later.

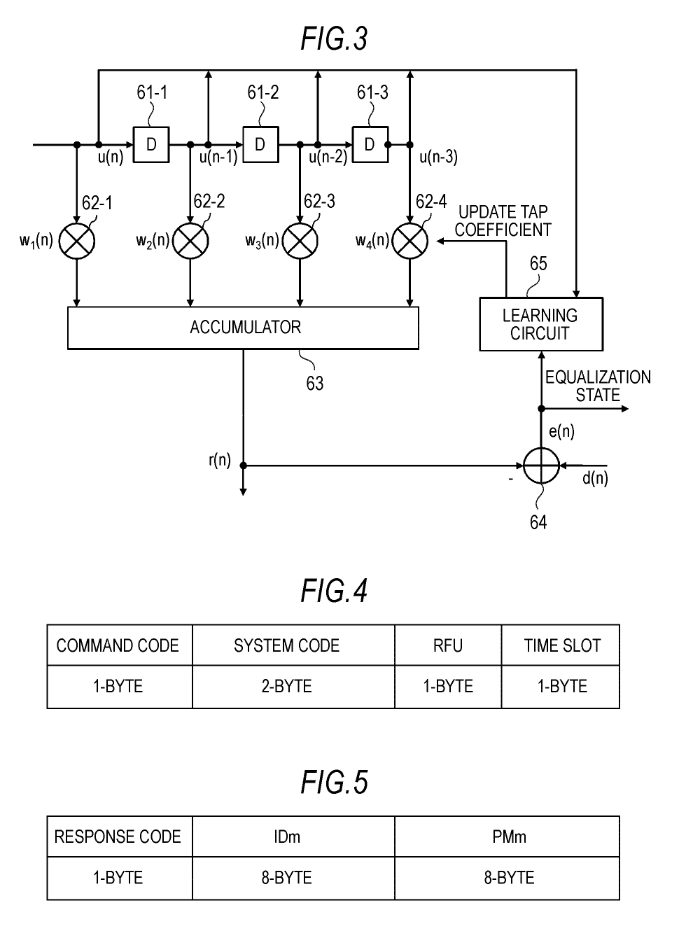

FIG. 3 shows an internal configuration example of an adaptive equalization unit which can be applied to the high-speed communication/adaptive equalization processing unit 15 on the reader/writer 10 side as well as the high-speed communication/adaptive equalization processing unit 36 on the transponder side 30. The shown adaptive equalization unit is configured to use NLMS (Normalized Learnt Mean Square) as a learning algorithm. Hereinafter, adaptive equalization processing will be explained with reference to the drawing and formulas.

The tap number of the shown FIR filter is M, and the filter includes a delay line in which (M−1) pieces of delay elements (D) 61-1, 61-2, . . . are connected in series (FIG. 3 is shown as M=4 for simplifying the drawing). Each delay element has delay time “D” corresponding to a sampling period, respectively.

Here, when a sampling time is “n” and the received signal at the time “n” is “u(n)”, time-series input data for the tap number M, namely, u(n), u(n−1), u(n−M+1) can be obtained.

Multipliers 62-1, 62-2, . . . as many as the tap number have tap coefficients w₁(n), w₂(n), wM(n) corresponding to filter characteristics respectively, performing weighted multiplication of the M-pieces of input data u(n), u(n−1), u(n−M+1), respectively.

An accumulator 63 adds and averages the time-series input data which have been weighted by corresponding tap coefficients respectively to obtain an equalized output signal “r(n)” at the time “n”. The above equalization processing can be represented as the following formula (1).

u^{T}(n)=[u(n),u(n−1),u(n−2), . . . ,u(n−M+1)[

w^{T}(n)=[w₁(n),w₂(n),w₃(n), . . . ,w_{M}(n)]

r(n)=w^{H}(n)·u(n) (1)

Subsequently, the learning of the tap coefficient will be explained. A reference signal d(n) is inputted to an adder 64 with the equalized output signal r(n), and an error signal e(n) which is the difference therebetween is outputted. The error signal e(n) will be a value indicating the progress state of learning. The high-speed communication/adaptive equalization processing unit 15 transmits the equalization state based on the error signal e(n) to the reader/writer control unit 16 through the equalization state transmitting signal 19. Also, the high-speed communication/adaptive equalization processing unit 36 transmits the equalization state based on the error state e(n) to the transponder control unit 37 through the equalization state transmitting signal 50.

In the embodiment, the transponder 30 uses a polling command POL received from the reader/writer 10 and the reader/writer 10 uses a polling response POLRES received from the transponder 30 as the reference signal d(n), and the details thereof will be described later.

When the time-series input data u(n), u(n−1), u(n−M+1) at the time “n” and the error signal e(n) are inputted, a learning circuit 65 determines tap coefficients wᵢ(n+1), w₂(n+1), . . . , wM(n+1) of the FIR filter at the next time by using the NLMS algorithm so that the equalized output signal “r” from the FIR filter comes close to the reference signal “d”, supplying them to respective multipliers 62-1, 62-2, . . . . Update formulas of the error signal e(n) and the tap coefficients are represented as the following formula (2).

$$e ( n ) = d ( n ) - r ( n ) \\ w ( n + 1 ) = w ( n ) + \frac{α \cdot u ( n )}{{‖ u ( n ) ‖}^{2}} \cdot {e}^{*} ( n ) \qquad ( 2 )$$

The update formulas shown in the above formula (2) are repeatedly performed, as a result, respective tap coefficients w1(n), w2(n), wM(n) of the FIR filter are converged so as to reduce the error signal e(n).

Here, “a” in the above formula (2) represents a step size, and 0<α<2. When “α” is close to “1”, convergence is performed at high speed, however, the variation of error is increased. When “α” is close to “0”, convergence is performed slowly, however, the variation of error is reduced.

After the learning has sufficiently progressed, the learning circuit 65 stops the learning function of the tap coefficient by the NLMS algorithm. Accordingly, equalization processing using the learned tap coefficient is continuously executed.

Return to FIG. 2, and communication operations in the contactless communication system will be explained.

The reader/writer 10 performs ASK modulation of a carrier signal of 13.56 MHz emitted for itself and transmits the signal to the transponder 30 by superimposing transmission data thereon. On the other hand, the transponder 30 transmits transmission data to the reader/writer 10 by performing load modulation on the unmodulated carrier of 13.56 MHz transmitted by the reader/writer 10.

The reader/writer 10, when receiving a communication start command from the host device 40, transmits the carrier wave first. After that, the reader/writer 10 transmits a response request signal by a method prescribed by the standard (carrier frequency, data modulation speed and data contents) for checking whether there exists a target in communicable space or not.

On the other hand, the transponder 30 is activated by power being supplied by inductive electromotive force of the carrier transmitted by the reader/writer 10 first and becomes in a receivable state, after that, receives the response request signal transmitted from the reader/writer 10. Then, when the received response request signal is a signal corresponding to the type of itself, the transponder 30 sends a response signal including identification information of itself by the method prescribed in the standard (data modulation speed, response timing and data contents) by performing load modulation on the unmodulated carrier from the reader/writer 10 to make a response.

The reader/writer 10, when receiving the response signal from the transponder 30, transmits the information to the host device 40. The host device 40, when recognizes the number of the transponders 30 existing in the communicable space and respective identification information, moves to a communication phase with respect to the specific transponder 30 in accordance with an operation program (firmware). Accordingly, passive interactive communication is established. After the communication is established, the reader/writer 10 continues emitting the carrier wave constantly until the necessary communication is completed, transmitting necessary power to the transponder 30.

Also at the time of data transmission, the data is transmitted by the intensity modulation of the carrier wave from the reader/writer 10 to the transponder 30 and load modulation of the unmodulated signal from the transponder 30 to the reader/writer 10 in the same manner as the above response request operation.

In the information communication field, a polling procedure is known, which makes inquiries periodically to plural devices or programs in order for avoiding competition, determining preparation status of transmission/reception, acquiring synchronization of processing and the like. In the Felica communication, the polling is used for initialization of communication as well as for avoiding collision.

The reader/writer 10 transmits a polling command repeatedly for detecting the transponder 30 existing in an operation magnetic field. On the other hand, the transponder 30 receives power in the RF operation magnetic field generated by the reader/writer 10, completes reception preparation of the polling command POL in a given time (5 ms) from the rising of power and waits. Then, the transponder 30, when receiving the polling command POL, sends back the polling response POLRES (in the case that system codes match to each other). The transponder 30 sends the response at random in respective time slots which can be controlled based on a time-slot principle.

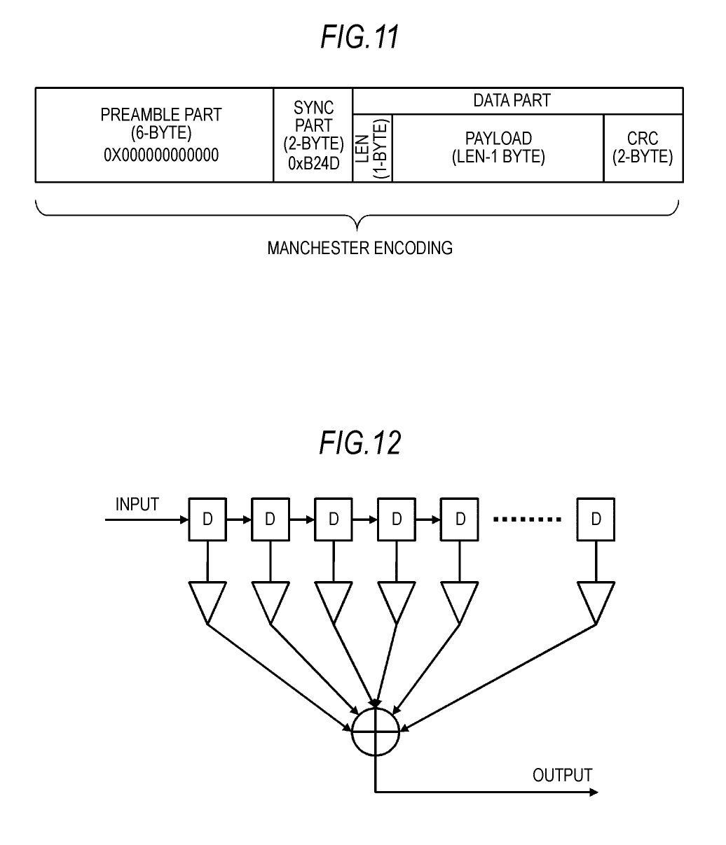

FIG. 4 shows a format of the polling command POL transmitted from the reader/writer 10. The drawing corresponds to a payload portion the packet of the Felica format (refer to FIG. 11).

A value of the command code is set to “00”. The system code is used for choosing a target transponder 30 by the reader/writer 10. When the value of the command code is “FFFF”, all transponders 30 can respond to the polling command POL. RFU (Reserved for Future ISO/IEC Use) is set to “00”. In the time slot, an optimum value of the time slot to be responded by the transponder 30 for avoiding collision is designated. Values which can be designated as the time slot are “00”, “01”, “03” “07” or “0F”.

FIG. 5 shows a format of the polling response POLRES trasnmitted from the transponder 30. The drawing corresponds to the payload portion of the packet of the Felica format (refer to FIG. 11).

A value of the response code is set to “01”. IDm has the 8-byte length, which is a manufacture ID of the transponder 30. PMm has 8-byte length, which is a manufacture parameter.

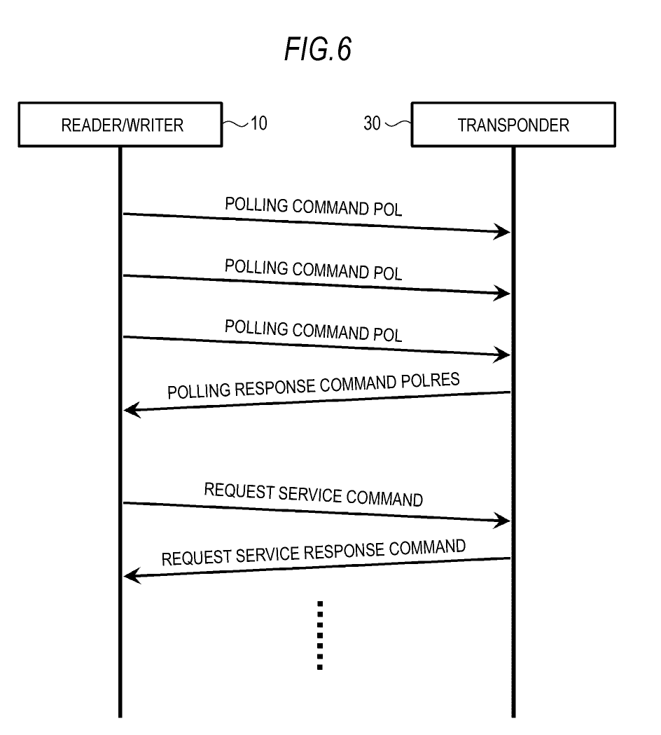

FIG. 6 shows a common (known communication) processing sequence of the polling command in the Felica communication system shown in FIG. 2.

At the time of starting communication, the reader/writer 10 receives an instruction from a control program (firmware etc.) and transmits the carrier. The Felica specifications do not prescribe the timing of transmitting the carrier, transmitting time and transmitting frequency, and these values depend on specifications of the control program.

The reader/writer 10, after transmitting the carrier, adds modulation to the carrier and transmits the polling command POL for checking whether there exists the transponder 30 in the communicable range (RF operation magnetic field) or not.

The reader/writer 10 can prescribe interval time in which the transponder 30 should send the polling response POLRES by changing the value of the time slot in the polling command POL.

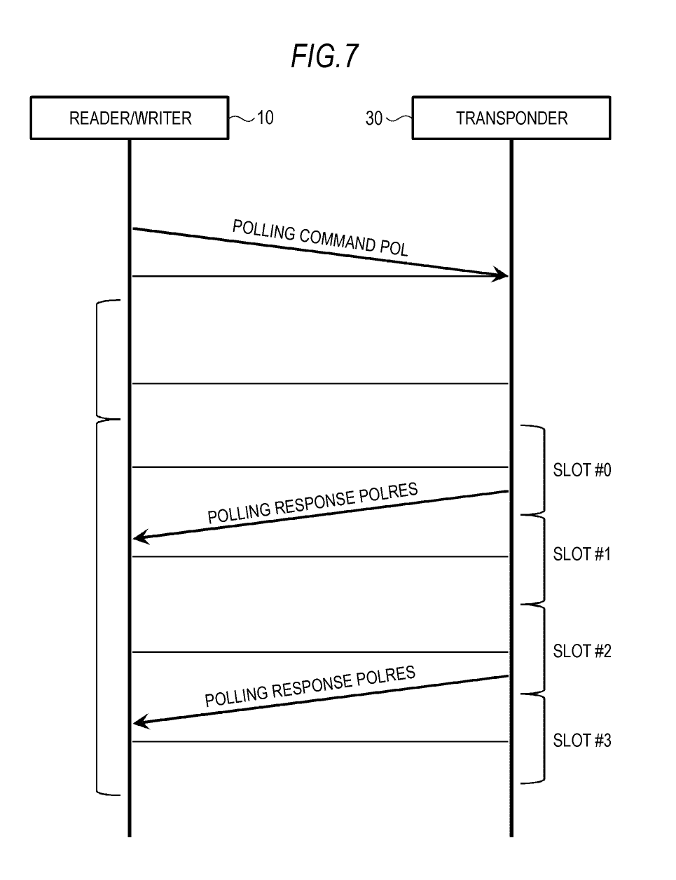

When the transponder 30 acquires power for operation by the carrier transmitted by the reader/writer 10 as well as receives the polling command normally, the transponder 30 sends the polling response POLRES to the reader/writer 10 in a time slot of 1.208 ms from a point when a slot start time calculated by the following formula (3) has passed after the reader/writer 10 has completed the transmission of the polling command POL. FIG. 7 shows a sequence of the time slot control of the polling response packet when the time slot is set to 03 h.

Slot Start Time

=2.417 ms+1.208 ms(random value in “time slot values within 0 to POL”) (3)

In the polling response POLRES, unique parameters IDm and PMm (refer to FIG. 5) having 16-byte written in the ROM area (not changed by the user) in the transponder 30 are written.

The reader/writer 10, when receiving the polling response POLRES from the transponder 30 normally, determines that the communication has been established and moves to protocol processing (Request Service Authentication, Read, Write and the like) in subsequent stages.

The reader/writer 10 can estimate the maximum time (time-out time) in which sending of the polling response POLRES is expected. The reader/writer 10, when not receiving the polling response POLRES within the time-out time, determines that the transponder 30 does not exist in the communicable range and transmits the polling command POL again. The specifications do not prescribe the timing of re-transmitting the polling command POL after the time-out time has passed, transmission frequency as well as time until the reader/writer gives up communication and stops the carrier transmission, and these values depend on specifications of the control program.

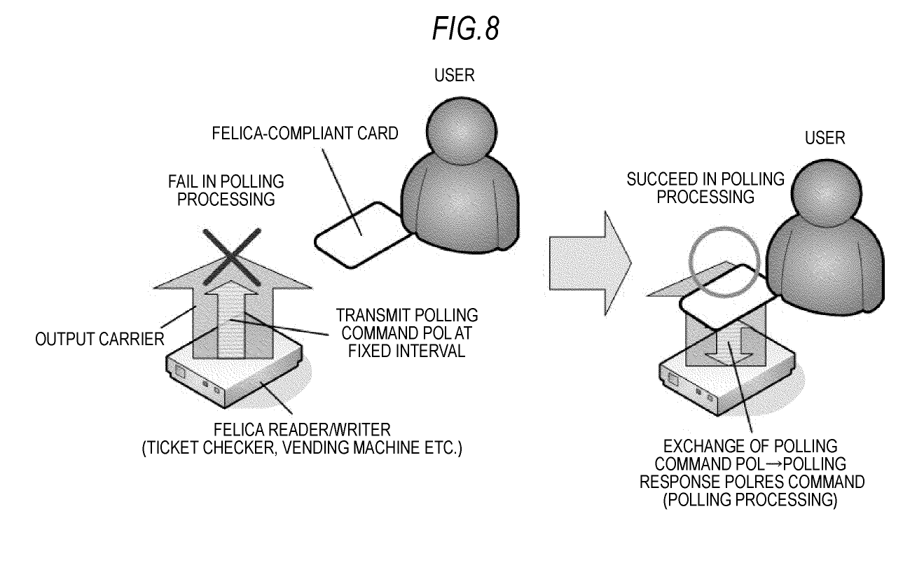

FIG. 8 shows a state in which the reader/writer 10 (a ticket checker, a vending machine and so on) performs polling processing by the operation of the transponder 30 (Felica-compliant card) by a user in the common Felica communication system.

For example, in the case that a human being brings the card close to the reader/writer at the automatic ticket checker or the like, it is easy to assume a situation in which the reader/writer receives the polling response POLRES after the polling processing failed several times. Therefore, it is permitted that the reader/writer 10 can re-transmit the polling command POL any number of times. On the other hand, it is prescribed that, on the transponder 30 side, an internal state is not changed after the polling response PORES has been send once, and when the polling command POL is received continuously, the polling response POLRES can be sent again in order to deal with the case that the transmitted polling response POLRES is not received by the reader/writer normally.

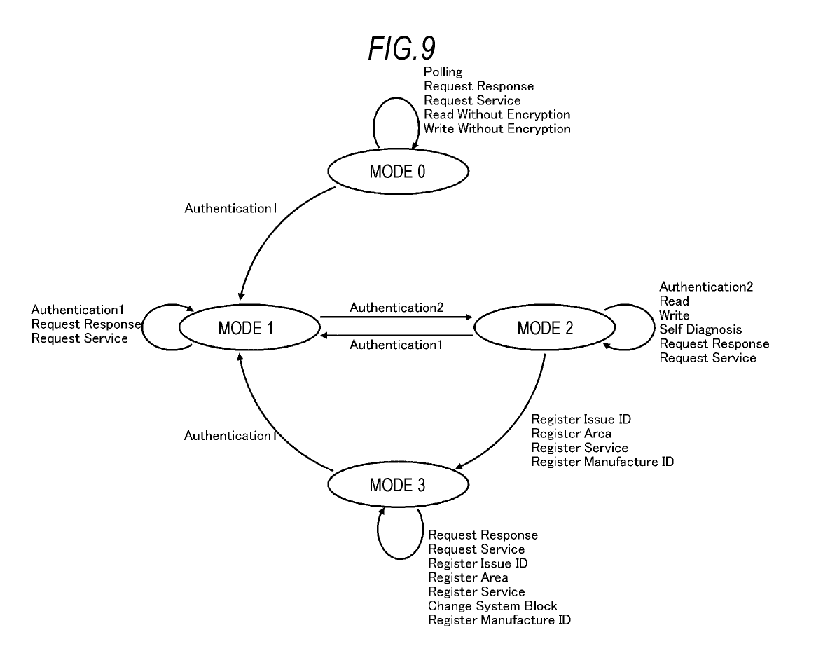

For reference purposes, mode transition of the transponder 30 is shown in FIG. 9. As shown in the drawing, the transponder 30 has four modes: a mode “0”, a mode 1, a mode 2 and a mode 3, changing the mode in accordance with execution of commands. Commands which can be executed by the transponder 30 are limited according to the present mode. When power is supplied, the transponder 30 becomes in the mode “0”. The present mode can be checked by Request Response command. Correspondence between execution modes of commands and mode transition after success will be shown in the following table. The mode transition is performed only when the command is normally executed.

TABLE 2

| command | mode transition after execution | | | |
|---|---|---|---|---|
| mode before command execution | 0 | 1 | 2 | 3 |
| Polling | 0 | — | — | — |
| Request Response | 0 | 1 | 2 | 3 |
| Request Service | 0 | 1 | 2 | 3 |
| Read Without Encryption | 0 | — | — | — |
| Write Without Encryption | 0 | — | — | — |
| Authentication1 | 1 | 1 | 1 | 1 |
| Authentication2 | — | 2 | 2 | — |
| Read | — | — | 2 | — |
| Write | — | — | 2 | |
| Register Issue ID | — | — | 3 | 3 |
| Register Area | — | — | 3 | 3 |
| Register Service | — | — | 3 | 3 |
| Change System Block | — | — | — | 3 |
| Register Manufacture ID | — | — | 3 | 3 |
| Self Diagnosis | — | — | 2 | — |

The format of the polling response POLRES transmitted by the transponder 30 is as shown in FIG. 5. From the drawing, the contents of the polling response POLRES may be changed according to change of the contents of the received polling command POL such as a value of the time slot, however, the contents of the polling response POLRES sending back from the same transponder 30 with respect to the polling command POL of the same contents (namely, re-transmitted command) are inevitably the same.

In other words, the polling response POLRES sent back from the same transponder 30 in response to the same polling command POS will be a known signal for the reader/writer 10. Also, the polling command POL sent back from the same reader/writer 10 without changing the contents will be a known signal for the transponder 30.

Therefore, the reader/writer 10 can give the long known signal to the transponder 30 by continuing re-transmitting the same polling command POL without changing the contents, and the transponder 30 can perform learning-type adaptive equalization by using the known signal as a training signal. The reader/writer 10 continues re-transmitting the polling command POL without changing the contents even when the polling response POLRES is received from the transponder 30 to thereby continue receiving the polling response POLRES of the same contents from the transponder 30 and obtain the long known signal, as a result, the learning-type adaptive equalization can be performed by using the known signal as the training signal.

The reader/writer 10 and the transponder 30 can obtain further longer training signal and make the equalization processing more efficient by adding signal patterns of the preamble part and the sync part of the packet of the Felica format to front portions of the polling response POLRES and the polling command POL obtained as the training signals, or adding the CRC of the 2-byte length at the termination of the data part of the same format to rear portions of the polling response POLRES and the polling command POL.

To perform the polling processing after the communication start is not prescribed as indispensable in the Felica specifications, and whether the communication system performs polling processing or not depends on the specifications of the control program. However, it is common that the reader/writer 10 performs polling processing first to check existence of the transponder 30 with which communication can be performed as well as to acquire unique parameters (IDm) necessary for performing communication processing of subsequent stages of protocols. Therefore, the method of obtaining the long training signal using re-transmission of the polling command POL from the reader/writer 10 is practical.

The equalization processing in the high-speed communication using the polling command POL and the polling response POLRES will be explained below.

As have been explained with reference to FIG. 2, the reader/writer 10 includes the known communication processing unit 14, the high-speed communication/adaptive equalization processing unit 15, the reader/writer control unit 16 controlling both known communication as well as high-speed communication together as well as the transponder 30 includes the known communication processing unit 35, the high-speed communication/adaptive equalization processing unit 36 and the transponder control unit 37 controlling both known communication as well as high-speed communication together. The known communication is the communication system which is relatively low in speed such as 212 kbps and 424 kbps, and waveform distortion does not become a problem. On the other hand, the high-speed communication has high-speed communication rates such as 848 kbps, 1.7 Mbps and 3.4 Mbps, in which waveform shaping by adaptive equalization is necessary. The high-speed communication/adaptive equalization processing units 15, 36 quantitatively transmit the equalization state of the signal receiving at present to the reader/writer control unit 16 and the transponder control unit 37, respectively. An example of the quantitative express method of the equalization state is the error signal e(n) between the equalization output signal r(n) and the reference signal d(n) of the equalization filter at the time “n” (refer to the above and FIG. 3).

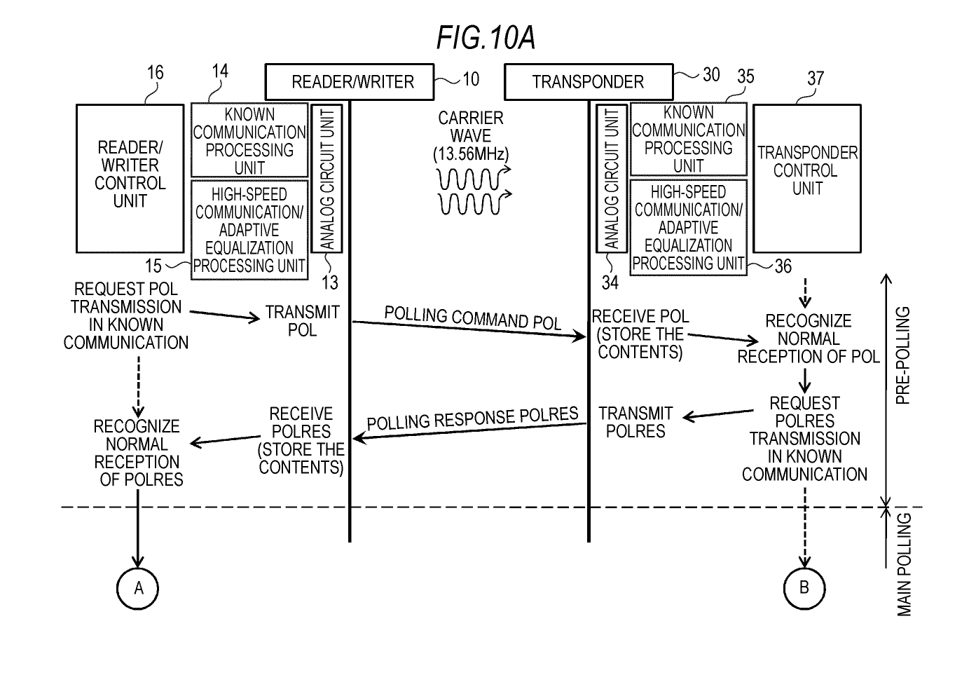

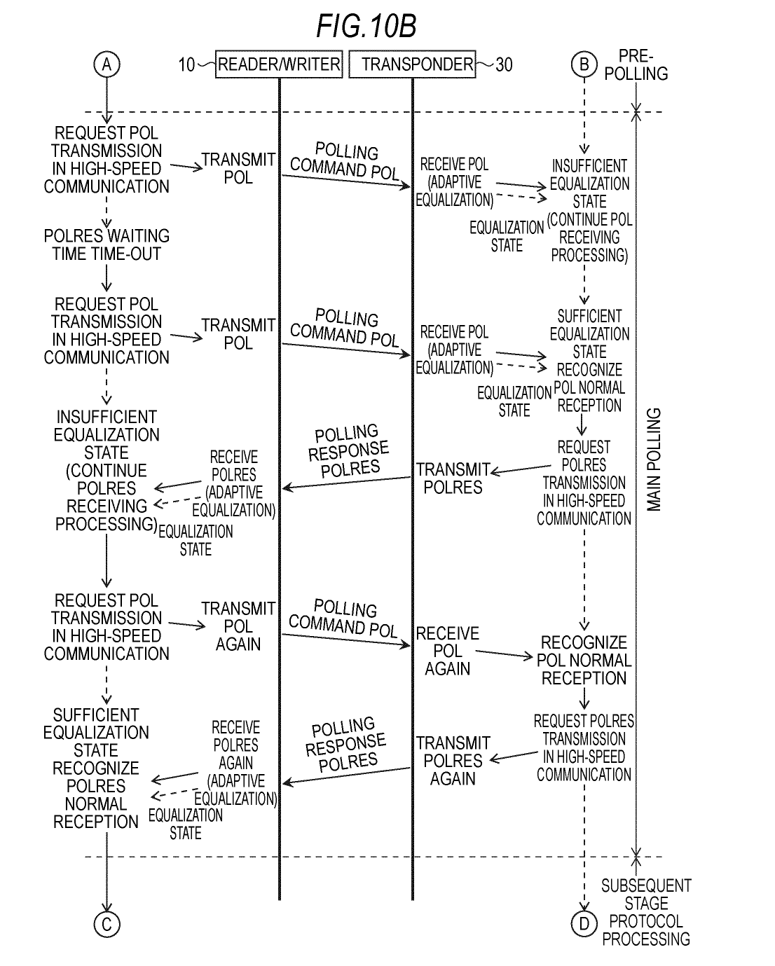

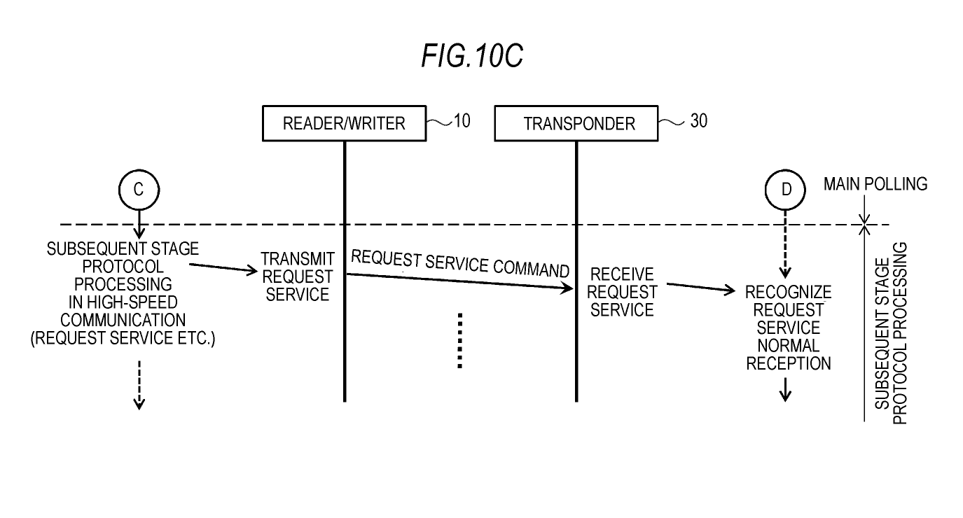

FIG. 10A to FIG. 10C show an equalization sequence in the high-speed communication using the polling command POL and the polling response POLRES. The shown processing sequence includes a “pre-polling” performing polling processing in the known communication and a “main polling” performing the polling processing in the high-speed communication. The main polling is completed when it is determined that the equalization state is sufficient in the reader/writer 10 and the transponder 30 respectively, and protocol processing of the subsequent stage by the high-speed communication is started.

First, the reader/writer 10 and the transponder 30 perform the pre-polling in the known Felica communication system.

In the reader/writer 10 side, the reader/writer control unit 16 requests the known communication control unit 14 to transmit the polling command POL, and the polling command POL is transmitted by the known communication.

In the transponder 30 side, receiving processing of the polling command POL is performed in the known communication processing unit 35, and the contents of the packet are stored in the hardware. The transponder control unit 37, when recognizing that the polling command POL has been normally received, requests the known communication processing unit 35 to transmit the polling response POLRES, and the polling command POL is transmitted by the known communication.

In the reader/writer 10 side, receiving processing of the polling response POLRES is performed in the known communication processing unit 14, the contents of the packet is stored in the hardware. When the reader/writer control unit 16 recognizes that the polling response POLRES has been normally received, the pre-polling is completed.

As described above, the training signal for learning of adaptive equalization can be exchanged between the reader/writer 10 and the transponder 30 by using the pre-polling processing in which waveform distortion does not become a problem before starting high-speed communication in which adaptive equalization processing is absolutely necessary.

Subsequently, the main polling is started. In the reader/writer 10 side, the reader/writer control unit 16 requests the high-speed communication/adaptive equalization processing unit 15 to transmit the polling command POL, and the polling command POL having the same contents as in the case of the pre-polling is transmitted at high-speed communication speed.

In the transponder 30 side, when receiving the polling command POL, the high-speed communication/adaptive equalization processing unit 36 performs adaptive equalization processing (learning of the equalization filter) by using the contents of the polling command POL stored at the time of the pre-polling as a training signal as well as transmits the equalization state to the transponder control unit 37. The transponder control unit 37, when determining that the equalization processing (learning of the equalization filter) in the adaptive processing is not sufficient from the transmitted equalization state, withholds the request for transmitting the polling response POLRES for continuing the receiving processing of the polling command POL and the learning of the equalization filter.

In the reader/writer 10 side, waiting time of the polling response POLRES is time-out, the reader/writer control unit 16 requests the high-speed communication/adaptive equalization processing unit 15 to transmit the polling command POL again, and the polling command POL having the same contents as in the case of the pre-polling is transmitted at the high-speed communication speed again.

In the transponder 30 side, when receiving the polling command POL again, the high-speed communication/adaptive equalization processing unit 36 continues the adaptive equalization processing (learning of the equalization filter) by using the contents of the polling command POL stored at the time of the pre-polling as the training signal as well as transmits the equalization state to the transponder control unit 37. The transponder control unit 37, when determining that the equalization state (learning of the equalization filter) in the adaptive processing is sufficient from the transmitted equalization state, recognizes that the polling command POL has been received normally and requests the high-speed communication/adaptive equalization processing unit 36 to transmit the polling response POLRES, as a result, the polling response POLRES is transmitted at the high-speed communication speed.

In the reader/writer 10 side, when receiving the polling response POLRES, the high-speed communication/adaptive equalization processing unit 15 performs adaptive equalization processing (learning of the equalization filter) by using the contents of the polling response POLRES stored at the time of the pre-polling as the training signal as well as transmits the equalization state to the reader/writer control unit 16. The reader/writer control unit 16, when determining that the equalization state (learning of the equalization filter) in the adaptive processing is not sufficient from the transmitted equalization state, requests the high-speed communication/adaptive equalization processing unit 15 to transmit the polling command POL again, and the polling command POL having the same contents as in the case of the pre-polling is transmitted again at the high-speed communication speed.

In the transponder 30 side, when receiving the polling command POL again, the transponder control unit 37 recognizes that the polling command POL has been normally received at once because the adaptive equalization (learning of the equalization filter) in the high-speed communication/adaptive equalization processing unit 36 has already been completed, requests the high-speed communication/adaptive equalization processing unit 36 to transmit the polling response POLRES again, and the polling response POLRES is transmitted again at the high-speed communication speed.

In the reader/writer 10 side, when receiving the polling response POLRES again, the high-speed communication/adaptive equalization processing unit 15 continues the adaptive equalization processing (learning of the equalization filter) by using the contents of the polling response POLRES stored at the time of the pre-polling as the training signal as well as transmits the equalization state to the reader/writer control unit 16. The reader/writer control unit 16, when determining that the equalization state (learning of the equalization filter) in the adaptive processing is sufficient, recognizes that the polling response POLRES have been normally received and determines that the communication has been established. As a result, the main polling is completed and the reader/writer 10 and the transponder 30 move to protocol processing (Request Service, Authentication, Read, Write and so on) in the subsequent stage using the high-speed communication speed.

According to the equalization processing sequence shown in FIG. 10A and FIG. 10B, it is possible to perform equalization processing at the time of high-speed communication while maintaining compatibility without affecting the upper protocol format at all as well as with little modification of the upper control programs.

In the equalization processing sequence as shown in FIG. 10A and FIG. 10B, the reader/writer 10 uses the polling response POLRES received from the transponder 30 at the time of the known communication as the training signal for the learning of the equalization filter, and the packet length is 18 or 20-byte including “LEN” which is necessarily added to the head of the packet. The transponder 30 uses the polling command POL received from the reader/writer 10 at the time of the known communication as the training signal, and the packet length is 6-byte. Both training signals has longer byte length than the case of using the preamble part and the sync part, therefore, equalization processing can be performed efficiently.

The polling command is shorter than the polling response POLRES as well as the contents of a signal series is likely to be biased (as shown in FIG. 4, the command code is “00×0” and the system code is “0xFFFF”, however, effects due to waveform distortion are commonly less severe in the modulation of the transmission signal from the reader/writer 10 side using the amplitude (ASK) modulation than in modulation of the transmission signal from the transponder 30 side using the load modulation, therefore, it is assumed that nonuniformity of both packets does not become a problem.

As shown in FIG. 8, in the use type in which the transponder 30 is a card-type and the user holds the card in the hand, for example, at the automatic ticket checker, the position between the reader/writer 10 and the transponder 30 varies temporally. In such case, the equalization processing is performed once in accordance with the processing procedure shown in FIG. 10A and FIG. 10B, however, it is preferable that the learning-type adaptive equalization processing using the preamble part and the sync part as the training signal or the blind-type adaptive equalization processing continuously are performed after the transition to the protocol processing in the subsequent stage.

In the equalization processing sequence shown in FIG. 10A to FIG. 10B, it is assumed that the contents of the polling command POL are the same at the time of the pre-polling and at the time of main polling. For convenience of the system, it is necessary to change the contents (time slot and the like) of the polling command at the time of the main polling. The equalization processing is performed by re-writing the contents of the polling command POL stored at the pre-polling based on the specifications on the transponder 30 side and by re-writing the contents of the polling response POLRES stored at the time of polling in accordance with the contents of the polling command POL transmitted for itself on the reader/writer side 10. The reader/writer 10 can estimate the contents of the polling response to be sent back based on the specifications of the Felica protocol even when values such as the time slot are changed by acquiring unique parameters of the transponder 30 such as IDm and PMm at the time of the pre-polling.

The invention has been explained in detail with reference to the specific embodiment as the above. However, it is obvious to those skilled in the art that various modifications and alternations can be made within a range not departing from the gist of the invention.

The equalization sequence as shown in FIG. 10A and FIG. 10B can be used together with the known equalization method such as the blind type and the learning-type adaptive equalization method using the preamble part and the sync part of the packet of the Felica format (refer to FIG. 11) in a range not reducing the compatibility of the protocol to thereby make the equalization processing more efficient.

Additionally, the signal pattern of the preamble part and the sync part of the packet of the Felica format is added to the front portion of the polling response POLRES and the polling command POL stored by the reader/writer 10 and the transponder 30 at the time of the pre-polling, or the CRC having the 2-byte length at the termination of the data part of the packet is added to the rear portion of the polling response POLRES and the polling command POL, thereby forming a further longer training signal and making the equalization processing more efficient.

In the present specification, an embodiment is applied to the contactless communication system in which the packet complying with the Felica format is exchanged between the reader/writer and the transponder has been mainly explained, however, the gist of the invention is not limited to this. The invention can be applied in the same manner to communication systems complying with various standards in which communication is performed by using modulation by switching the change direction of electrical load.

In short, the present application has been disclosed in the form of exemplification, and the descriptive contents of the specification should not be construed in a limited sense. In order to determine the gist of the invention, claims should be taken into consideration.

It should be understood that various changes and modifications to the presently preferred embodiments described herein will be apparent to those skilled in the art. Such changes and modifications can be made without departing from the spirit and scope and without diminishing its intended advantages. It is therefore intended that such changes and modifications be covered by the appended claims.

The application is claimed as follows:

1. A communication device comprising:
a first communication processing unit performing contactless communication operations in a first communication rate in which waveform distortion hardly become a problem;
a second communication processing unit performing contactless communication operations in a second communication rate in which waveform shaping by adaptive equalization is necessary; and
a control unit controlling communication processing by the first and second communication processing units,
wherein the first communication processing unit stores the contents of a packet received in the first communication rate, and
the second communication processing unit, when receiving the packet of the same contents in the second communication rate, performs adaptive equalization processing by using the stored contents of the packet.

2. The communication device according to claim 1,
wherein the second communication processing unit notifies an equalization state of the adaptive equalization processing to the control unit,
the control unit performs the adaptive equalization processing using the stored contents of the packet continuously until the equalization state is determined to be sufficient.

3. The communication device according to claim 1,
wherein the communication device is applied to a contactless communication system including a reader/writer and a transponder, in which a polling command is transmitted from the reader/writer and a polling response is sent back from the transponder,
the polling command is permitted to be continuously transmitted plural times from the reader/writer as well as the transponder sends back the polling response having the same contents with respect to the polling command having the same contents.

4. The communication device according to claim 3,
wherein the communication device is operated as the reader/writer,
the reader/writer transmits the polling command using the first communication processing unit and receives the polling response sent back from the transponder as well as stores the contents thereof, and
the reader/writer transmits the same polling command by using the second communication processing unit and performs adaptive equalization processing by using the stored contents of the packet when receiving the polling response sent back from the transponder.

5. The communication device according to claim 4,
wherein the second communication processing unit notifies an equalization state of the adaptive equalization processing to the control unit, and
the control unit transmits the same polling command again by using the second communication processing unit until the equalization state is determined to be sufficient, and performs adaptive equalization processing using the stored contents of the packet continuously when receiving the polling response sent back from the transponder.

6. The communication device according to claim 3,
wherein the communication device is operated as the transponder,
the transponder stores the contents of the polling command in response to normal reception of the command by the first communication processing unit as well as sends back the polling response, and
the transponder receives the same polling command by the second communication processing unit and performs adaptive equalization processing by using the stored contents of the packet.

7. The communication device according to claim 6,
wherein the second communication processing unit notifies an equalization state of the adaptive equalization processing to the control unit, and
the control unit does not send back the polling response from the second communication processing unit until the equalization state is determined to be sufficient, receives the same polling command transmitted from the reader/writer again by the second communication processing unit and performs adaptive equalization processing continuously by using the stored contents of the packet.

8. A communication method as a reader/writer in a contactless communication system including the reader/writer and a transponder, in which a polling command is transmitted from the reader/writer and a polling response is sent back from the transponder, the polling command is permitted to be continuously transmitted plural times from the reader/writer as well as the transponder sends back the polling response having the same contents with respect to the polling command having the same contents, the method comprising:
transmitting the polling command by performing a contactless communication operation in a first communication rate in which waveform distortion hardly become a problem, receiving the polling response sent back from the transponder and storing the contents thereof; and
transmitting the same polling command again by performing a contactless communication operation in a second communication rate in which waveform shaping by adaptive equalization is necessary until an equalization state is determined to be sufficient, and performing the adaptive equalization processing continuously by using the stored contents of the packet when receiving the polling response sent back from the transponder.

9. A communication method as a transponder in a contactless communication system including a reader/writer and the transponder, in which a polling command is transmitted from the reader/writer and a polling response is sent back from the transponder, the polling command is permitted to be continuously transmitted plural times from the reader/writer as well as the transponder sends back the polling response having the same contents with respect to the polling command having the same contents, the method comprising:
storing the contents of the polling command in response to normal reception of the command by performing a contactless communication operation in a first communication rate in which waveform distortion hardly become a problem as well as sending back the polling response; and
performing a contactless communication operation in a second communication rate in which waveform shaping by adaptive equalization is necessary without sending back the polling response until an equalization state is determined to be sufficient, and performing adaptive equalization processing continuously by using the stored contents of the packet when receiving the same polling command transmitted from the reader/writer again.

10. A computer program written in a computer readable format so as to execute processing as a reader/writer on the computer in a contactless communication system including a reader/writer and a transponder, in which a polling command is transmitted from the reader/writer and a polling response is sent back from the transponder, the polling command is permitted to be continuously transmitted plural times from the reader/writer as well as the transponder sends back the polling response having the same contents with respect to the polling command having the same contents, allowing a computer to execute the steps of:
transmitting the polling command by performing a contactless communication operation in a first communication rate in which waveform distortion hardly become a problem, receiving the polling response sent back from the transponder and storing the contents thereof; and
transmitting the same polling command again by performing a contactless communication operation in a second communication rate in which waveform shaping by adaptive equalization is necessary until an equalization state is determined to be sufficient, and performing the adaptive equalization processing continuously by using the stored contents of the packet when receiving the polling response sent back from the transponder.

11. A computer program written in a computer readable format so as to execute processing as a transponder on the computer in a contactless communication system including a reader/writer and a transponder, in which a polling command is transmitted from the reader/writer and a polling response is sent back from the transponder, the polling command is permitted to be continuously transmitted plural times from the reader/writer as well as the transponder sends back the polling response having the same contents with respect to the polling command having the same contents, allowing a computer to execute the steps of:
storing the contents of the polling command in response to normal reception of the command by performing a contactless communication operation in a first communication rate in which waveform distortion hardly become a problem as well as sending back the polling response; and
performing a contactless communication operation in a second communication rate in which waveform shaping by adaptive equalization is necessary without sending back the polling response until an equalization state is determined to be sufficient, and performing adaptive equalization processing continuously by using the stored contents of the packet when receiving the same polling command transmitted from the reader/writer again.

12. A contactless communication system including a reader/writer and a transponder, in which a polling command is transmitted from the reader/writer and a polling response is sent back from the transponder, the polling command is permitted to be continuously transmitted plural times from the reader/writer as well as the transponder sends back the polling response having the same contents with respect to the polling command having the same contents,
wherein the reader/writer transmits the polling command by performing a contactless communication operation in a first communication rate in which waveform distortion hardly become a problem, receives the polling response sent back from the transponder and storing the contents thereof, then, transmits the same polling command again by performing a contactless communication operation in a second communication rate in which waveform shaping by adaptive equalization is necessary until an equalization state is determined to be sufficient, and performs the adaptive equalization processing continuously by using the stored contents of the packet when receiving the polling response sent back from the transponder, and
the transponder stores the contents of the polling command in response to normal reception of the command by performing a contactless communication operation in the first communication rate in which waveform distortion hardly become a problem as well as sends back the polling response, then, performs a contactless communication operation in a second communication rate in which waveform shaping by adaptive equalization is necessary without sending back the polling response until an equalization state is determined to be sufficient, further, performs adaptive equalization processing continuously by using the stored contents of the packet when receiving the same polling command transmitted from the reader/writer again.

13. A contactless communication system including a reader/writer and a transponder, in which a polling command is transmitted from the reader/writer and a polling response is sent back from the transponder, the polling command is permitted to be continuously transmitted plural times from the reader/writer as well as the transponder sends back the polling response having the same contents with respect to the polling command having the same contents,
wherein, after the reader/writer and the transponder exchange the polling command and the polling response by performing contactless communication operation in a first communication rate, the reader/writer and the transponder further exchange the polling command and the polling response by performing contactless communication operation in a second communication rate to perform subsequent protocol processing in the second communication rate
